(19) United States
(12) Patent Application Publication
(10) Pub. No.: US 2012/0103812 A1
(43) Pub. Date: May 3, 2012

(54) METHOD FOR FLOW MEASUREMENT

(76) Inventor: Claudius Zelenka, Moenkeberg (DE)

(21) Appl. No.: 12/916,536

(22) Filed: Oct. 30, 2010

(51) Int. Cl. G01N 27/447

(52) U.S. Cl. 204/547

(57) ABSTRACT

A novel method for capacitive flow measurement is disclosed, which is particularly suitable for media with low electrical conductivity.

An alternating electrostatic field with a perpendicular component to the flow direction is generated with a system of electrodes. On the electrodes, which are placed side by side in the flow direction, electrical currents are measured. The speed of the media is calculated from the electrode currents. Direct contact between the electrodes and the medium is possible, but not required. The material of the electrodes has no influence on the accuracy of the measurement. Essential advantage of the novel method is its absolute accuracy.

### BACKGROUND OF THE INVENTION

Many methods for flow measurement are already known. Most widely used are mechanical measuring devices, which are based on evaluation of the motion of a propeller or wheel in the flow.

Such devices meet low cost requirement, but their accuracy is low due to moving mechanical parts.

Other known methods use the generation and evaluation of turbulence in moving media.

Further known methods use measurement of the Doppler Effect in moving media.

These known methods need complex electronics, which is also required for flow measuring methods based on magnetoinductive effects.

Other known methods are based on the evaluation of heat transfer between the medium and a heated surface.

All known methods for flow measurement have their distinct areas of application; they all have their advantages and disadvantages. Basic problem of all known method is the long term accuracy and stability.

### BRIEF SUMMARY OF THE INVENTION

All known methods for flow measurement have limited long term accuracy and stability. In this invention a novel method for flow measurement is disclosed. An alternating electrostatic field with a perpendicular component to the flow direction is generated with a system of electrodes. On the electrodes, which are placed side by side in the flow direction, electrical currents are measured. The speed of the medium is calculated from the electrode currents.

This method is especially suited for low conducting or not conducting media. The novel method makes use of alternate drive voltage and therefore requires no direct electrical contact between the electrodes and the medium. The accuracy of the measurement is not dependent on the dielectric constant of the medium. Very high long term stability without periodic calibration can be achieved. This combination of properties distinguishes this novel method from prior art.

### BRIEF DESCRIPTION OF THE FIGURES

The present invention may be described with a greater clarity and specificity by referring to the following figures:

FIG. 1 illustrates an example design of an apparatus based on the novel method.

FIG. 2 illustrates an electrode configuration using four electrodes.

### DETAILED DESCRIPTION OF THE INVENTION

In this invention a novel capacitive method for flow measurement is disclosed. The novel method is especially suited for low conducting or not conducting media.

The novel method provides flow speed measurement with very high long term stability.

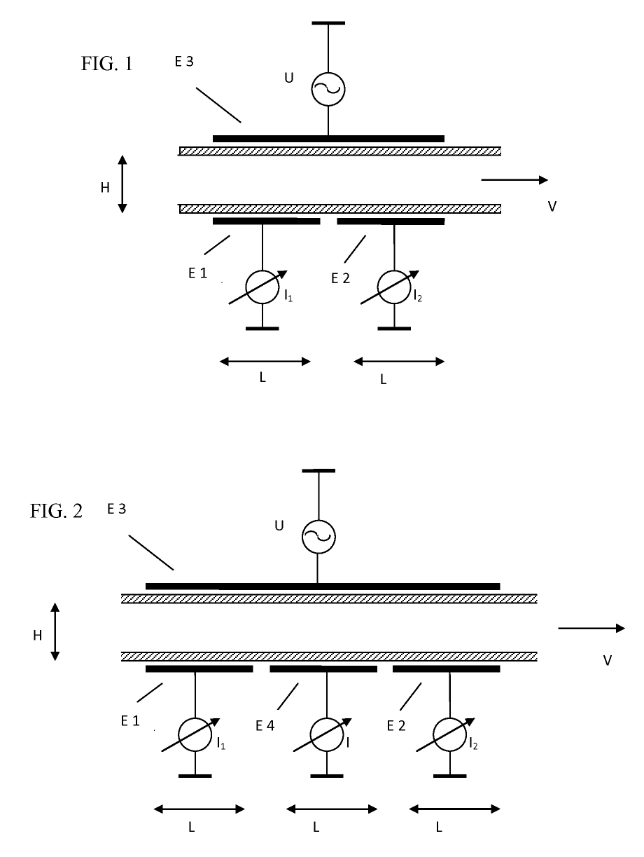

The basic principle of the novel method is disclosed on the FIG. 1.

In a measuring flume, which consists of a non-conducting material, a system of electrodes is placed, which in the basic configuration consists of three parts.

On one side of the flume the electrode E3 is driven with alternate voltage U.

On the other side electrodes E1 and E2 are placed. The distance between the electrodes E1 and E2 is kept small.

For the sake of simplicity let us assume, that the walls of the measuring flume are thin and the distance between the electrodes and the medium is very small. The electrodes E1 and E2 have identical dimensions and the medium is not electrically conductive.

The speed of the medium is determined by evaluating the the electric currents at the electrodes E1 and E2.

If the medium is not moving, the current through both electrodes E1 and E2 will have identical magnitude.

Let us assign:
F Frequency for measurement
L Length of the electrode
B Width of the electrode
H Height of the flow measuring flume
I₁ Current measured on electrode 1
I₂ Current measured on electrode 2
C Capacity between E3 and E1 and E3 and E2
εᵣ Relative dielectric constant
ε₀ Dielectric constant of vacuum
   Without flow the electric current will be:

I=I₁=I₂=2πFCU=2πFUεᵣε₀BL/H (1)

From (1) the dielectric index of the medium can be calculated:

εᵣ=I/(2πFUε₀BL/H) (2)

In case of a flowing medium, the currents I₁ and I₂ will change.

If the flow direction is as indicated by the arrow, the current I₁ will increase and the current I₂ will decrease. The reason is polarization of the medium upon entering the electrical field on the first electrode E1, and depolarization of the medium on the second electrode E2, upon leaving the electrical field.

Let us assign:
V Speed of the medium

If the medium moves with speed V, the currents of the electrodes will change:

I₁=I+ΔI (3)

I₂=I−ΔI (4)

I=(I₁+I₂)/2 (5)

ΔI=(I₁−I₂)/2=IV/(LF)(εᵣ−1)/εᵣ) (6)

The flow speed can be calculated:

V=LF(ΔI/I)(εᵣ/(εᵣ−1)) (7)

In (6) only the dielectric fraction of the current has been accounted for.

From the measured currents I₁ and I₂, using equation (5), the current I can be calculated. From the equation (2) the relative dielectric constant εᵣ of the medium can be calculated. The speed of the medium can then be calculated using the equation (7).

In the following typical application example the size of the measuring flume will be assumed to be 1 cm×1 cm.

The electrodes are also assumed to have the dimensions 1 cm×1 cm.

The capacity C will then be in the range ca. 0.3 . . . 6 pF, depending on the dielectric constant of the medium.

At U=100 V and F=1 kHz the magnitude of current I on the electrode will be in the range ca. 0.2 . . . 4 μA.

Now let us assume flow speed 1 cm/s. Following equation (6) ΔI≈10⁻³ I, which is in the range ca. 0.2 . . . 4 nA.

These values can easily be measured with modern electronics.

The novel method makes use of alternate drive voltage and therefore requires no direct electrical contact between the electrodes and the media. Electrochemical effects on the electrodes can be avoided. As shown in equation (2), change of the dielectric constant of the medium has not influence on the accuracy of measurement. The novel method will provide accurate measurement even with changing dielectric constant of the media. The novel method achieves very high long term stability and generally does not require periodic calibration. This combination of properties distinguishes this novel method from prior art.

In a practical design of the invention it may be difficult to build the electrodes with identical electrical capacity.

In this case a calibration step is necessary, which allows calculation of correction factors for the currents I₁, I₂ and possibly I₃.

It may be also technically advantageous, to use electrodes of different sizes and forms.

In such cases it is again necessary to determine the correction factors for the currents of the electrodes.

The electrodes can match the shape of the measuring flume, which may be for example elliptical or cylindrical.

In further development of the basic principle of the invention, an additional electrode E4 can be placed between the electrodes E1 and E2. The spacing between the electrodes is considered as small. This configuration is depicted on FIG. 2.

Through the electrode E4 flows constant current I, which is independent of the flow speed of the medium.

Current measurement on the middle electrode E4 can be used for supervision of the correct function of the flow meter.

Furthermore the electrodes, on which the currents are measured, do not have to be placed on the same side of the flume nor be adjacent to each other.

It is also possible to use an electrical field or electrical fields, which are not perpendicular to the direction of the mediums movement, which results in smaller currents, but continues to provide functionality, if a component of the electrical field remains perpendicular to the direction of the mediums movement.

The novel method also permits measurement of flow with low conductivity media, as for example water.

A low conductivity medium behaves as complex impedance. The complex impedance of the electrodes depends on the flow speed due to the polarization and depolarization of the medium. From the electrode currents I₁ and I₂ the complex impedance can be calculated and used for the flow speed measurement.

In a further development of the invention, it is intended to perform the measurement at several different frequencies. In this way the dynamic range and the accuracy of the measurement can be enhanced.

What is claimed is:

1. Method for measurement of the speed of moving media, using an electrode system for generation of an alternating electrical field, with a component perpendicular to the direction of the movement, characterized by the evaluation of electrical currents on at least two electrodes, located along the direction of the mediums movement.

2. Method according to claim 1, where the medium is liquid.

3. Method according to claim 1, where the medium is solid.

4. Method according to claim 1, where the medium is gaseous.

5. Method according to any of claims 1 to 4, where multiple electrical fields are used.

6. Method according to any of claims 1 to 5, where the currents of the electrodes are used for calculation of the complex impedance of the media.

7. Method according to any of claims 1 to 6, where the measurement occurs at several different frequencies.
